(19) United States
(12) Patent Application Publication
(10) Pub. No.: US 2025/0105782 A1
(43) Pub. Date: Mar. 27, 2025

(54) SOLAR POWER SYSTEM

(71) Applicant: Quanta Computer Inc., Taoyuan City (TW)

(72) Inventor: Sheng-Feng CHEN, Taoyuan City (TW)

(21) Appl. No.: 18/539,439

(22) Filed: Dec. 14, 2023

(30) Foreign Application Priority Data
Sep. 27, 2023 (TW) 112137029

(51) Int. Cl. H02S 40/32; H02J 3/38; H02M 7/5395

(52) U.S. Cl. CPC H02S 40/32; H02J 3/381; H02M 7/5395; H02J 2300/24

(57) ABSTRACT

A solar power system is provided. The solar power system includes a first solar photovoltaic panel and a first DC optimizer. The first solar photovoltaic panel converts light energy into electrical energy to generate a first solar voltage. The first DC optimizer receives the first solar voltage and performs a first voltage decreasing operation on the first solar voltage according to a first pulse width modulation signal to generate a first conversion voltage. The first DC optimizer adjusts a first duty cycle of the first pulse width modulation signal according to the first conversion voltage.

### CROSS REFERENCE TO RELATED APPLICATIONS

This Application claims priority of Taiwan Patent Application No. 112137029, filed on Sep. 27, 2023, the entirety of which is incorporated by reference herein.

### BACKGROUND OF THE INVENTION

### Field of the Invention

The present invention relates to a solar power system, in particular to a solar power system with an improved DC optimizer.

### Description of the Related Art

In recent years, the solar energy industry has developed rapidly due to environmental awareness. In a solar power generation system, multiple solar power modules are connected in series to generate a higher direct-current (DC) voltage, and a back-end converter converts the DC voltage into an alternating current (AC) voltage for users. For multiple solar power modules, each solar power module produces different power due to its environment (for example, whether it is shaded), degree of dirt, model, age, installation angle, etc. In order to obtain the maximum power output of each solar power module, a DC optimizer is installed in a solar power generation system. However, existing DC optimizers use voltage converters (boost-buck DC converters) with complex circuit and adopt maximum power tracking methods performed by complex calculations, which increases the area, cost, and calculation time of the DC optimizers.

### BRIEF SUMMARY OF THE INVENTION

An exemplary embodiment of a solar power system. The solar power system comprises a first solar photovoltaic panel and a first DC optimizer. The first solar photovoltaic panel converts light energy into electrical energy to generate a first solar voltage. The first DC optimizer receives the first solar voltage and performs a first voltage decreasing operation on the first solar voltage according to a first pulse width modulation signal to generate a first conversion voltage. The first DC optimizer adjusts a first duty cycle of the first pulse width modulation signal according to the first conversion voltage.

### BRIEF DESCRIPTION OF THE DRAWINGS

The present invention can be more fully understood by reading the subsequent detailed description and examples with references made to the accompanying drawings, wherein:

FIG. 1 shows one exemplary embodiment of a solar power system;

FIG. 2 shows another exemplary embodiment of a solar power system;

FIG. 3 shows one exemplary embodiment of a solar photovoltaic panel and a DC optimizer;

FIG. 4 shows an exemplary embodiment of a microcontroller;

FIG. 5 is a flow chart of an exemplary embodiment of maximum voltage tracking;

FIG. 6 shows another exemplary embodiment of a solar photovoltaic panel and a DC optimizer; and

FIG. 7 shows an exemplary embodiment of a solar photovoltaic panel, a DC optimizer, and a voltage stabilizing circuit.

### DETAILED DESCRIPTION OF THE INVENTION

The following description is made for the purpose of illustrating the general principles of the invention and should not be taken in a limiting sense. The scope of the invention is best determined by reference to the appended claims.

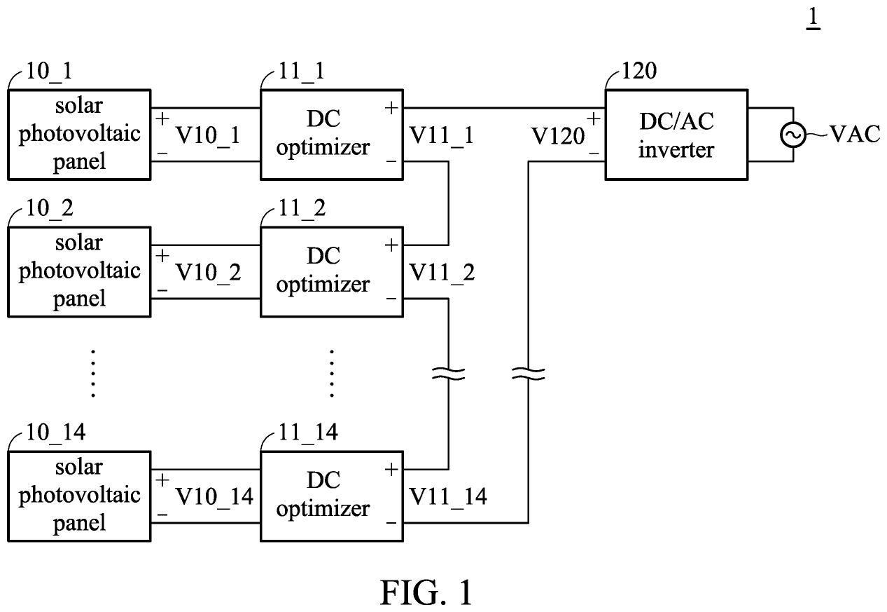

FIG. 1 shows one exemplary embodiment of a solar power system. Referring to FIG. 1, a solar power supply system 1 comprises a plurality of solar photovoltaic panels, a plurality of DC (direct-current) optimizers, and a DC to AC (alternating-current) (DC/AC) inverter (a power inverter) 120. In the embodiment of FIG. 1, one solar photovoltaic panel corresponds to one DC optimizer. For example, the solar power supply system 1 comprises 14 solar photovoltaic panels 10_1-10_14 and 14 DC optimizers 11_1-11_14. Each solar photovoltaic panel comprises a plurality of solar cells connected in series, and each solar cell can convert light energy into electrical energy. The solar photovoltaic panels 10_1-10_14 convert the received light energy into electrical energy and generate solar voltages V10_1-V10_14 respectively. The DC optimizers 11_1-11_14 receive the solar voltages V10_1-V10_14 respectively.

The DC optimizers 11_1-11_14 are connected in a series. As shown in FIG. 1, each DC optimizer has a positive output terminal (+) and a negative output terminal (−). The negative output terminal of the DC optimizer 11_1 is coupled to the positive output terminal of the DC optimizer 11_2, and the negative output terminal of the DC optimizer 11_2 is coupled to the positive output terminal of the DC optimizer 11_3. By analogy, the negative output terminal of the DC optimizer 11_13 is coupled to the positive output terminal of the DC optimizer 11_14. The positive output terminal of the DC optimizer 11_1 and the negative output terminal of the DC optimizer 11_14 are coupled to the two input terminals of the DC/AC inverter 120. Each DC optimizer performs a voltage decreasing operation on the received solar voltage based on a pulse width modulation signal to generate a corresponding conversion voltage. For example, the DC optimizer 11_1 performs a voltage decreasing operation on the received solar voltage V10_1 to generate a corresponding conversion voltage V11_1, the DC optimizer 11_2 performs a voltage decreasing operation on the received solar voltage V10_2 to generate a corresponding conversion voltage V11_2, and the DC optimizer 11_14 performs a voltage decreasing operation on the received solar voltage V10_14 to generate a corresponding conversion voltage V11_14. For each DC optimizer, during the corresponding voltage decreasing operation, the DC optimizer can change the generated conversion voltage by adjusting the duty cycle of the corresponding pulse width modulation signal so that the corresponding solar photovoltaic panel can operate at its maximum output power point.

Based on the series structure of the DC optimizers 11_1-11_14, the DC optimizers 11_1-11_14 output the conversion voltages V11_1-V11_14 in series as a series DC input voltage V120. In details, the series DC input voltage V120 is equal to the sum of the conversion voltages V11_1-V11_14. The DC/AC inverter 120 receives the series DC input voltage V120 and performs a DC/AC conversion operation on the series DC input voltage V120 to convert the series DC input voltage V120 into an AC output voltage VAC.

For example, the solar photovoltaic panels 10_1-10_14 have the same amount of sunshine, environmental conditions, device status (for example, degree of dirtiness), device parameters (for example, device models, installation angles), and the amount of the generated power of each of the solar photovoltaic panels 10_1-10_14 is 32 volts (V)/6.25 amps (A) (that is, the power is 32V*6.25 A=200 watts (W)). In addition, the duty cycle of the pulse width modulation signal for each of the DC optimizers 11_1-11_14 to perform the corresponding voltage decreasing operation is 100%. In this case, the output generated by each of the DC optimizers 11_1-11_14 is 32V/6.25 A. In other words, the conversion voltages V11_1-V11_14 are all 32V. The input voltage of the DC/AC inverter 120 (that is, the series DC input voltage V120) is 448V (32V*14=448V), and the input current of the DC/AC inverter 120 is 6.25 A. Thus, the input power is 2800 W (448V*6.25 A=2800 W).

For example, when one of the solar photovoltaic panels 10_1-1_14 (for example, the solar photovoltaic panel 10_1) is obscured by clouds, its maximum output power is approximately 40 W (28V*1.43 A=40.04 W). At this time, the DC optimizer 11_1 performs a maximum-voltage tracking operation to change the conversion voltage V11_1 generated by the DC optimizer 11_1 by adjusting the duty cycle of the pulse width modulation signal for the voltage decreasing operation so that the DC optimizer 11_1 has the maximum voltage value (6.4V). Therefore, the output power of the DC optimizer 11_1 is 40 W (6.4V*6.25 A=40 W), which is approximately equal to the maximum output power of the solar photovoltaic panel 10_1. According to the above description, the DC optimizer 11_1 tracks the maximum voltage value of the conversion voltage V11_1 by changing the duty cycle of the pulse width modulation signal so that the solar photovoltaic panel 10_1 can operate at the maximum output power point.

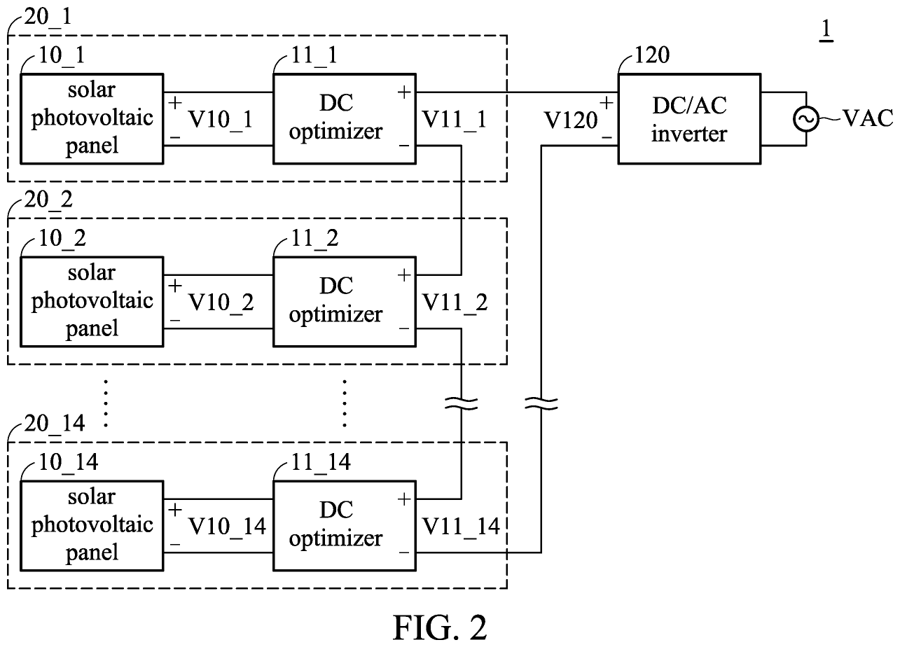

In one embodiment, each solar photovoltaic panel is arranged in a solar power module, and a DC optimizer is not set in the solar power module where the corresponding solar photovoltaic panel is arranged, that is, a solar photovoltaic panels and a corresponding DC optimizer are not arranged in the same solar power module. In another embodiment, a solar photovoltaic panels and a corresponding DC optimizer are arranged in the same solar power module. As shown in FIG. 2, for example, the solar photovoltaic panel 10_1 and the corresponding DC optimizer 11_1 are arranged in the same solar power module 20_1, the solar photovoltaic panel 10_2 and the corresponding DC optimizer 11_2 are arranged in the same solar power module 20_2, and the solar photovoltaic panel 10_14 and the corresponding DC optimizer 11_14 are arranged in the same solar power module 20_14. Compared with the case where a solar photovoltaic panel and a corresponding DC optimizer are not arranged in the same solar power module, in the case where a solar photovoltaic panel and a corresponding DC optimizer are arranged in the same solar power module, the number of wires and connectors required for the connection between a solar photovoltaic panel and a corresponding DC optimizer is decreased, thereby reducing cost. In addition, in the case where a solar photovoltaic panels and a corresponding DC optimizer are arranged in the same solar power module, the assembly complexity and the assembly man-hours can be reduced.

The following paragraphs will take the solar photovoltaic panel 10_1 and the corresponding DC optimizer 11_1 as an example to explain how the DC optimizers in the embodiment change the generated conversion voltages, that is, how to track the maximum voltage values of the conversion voltages.

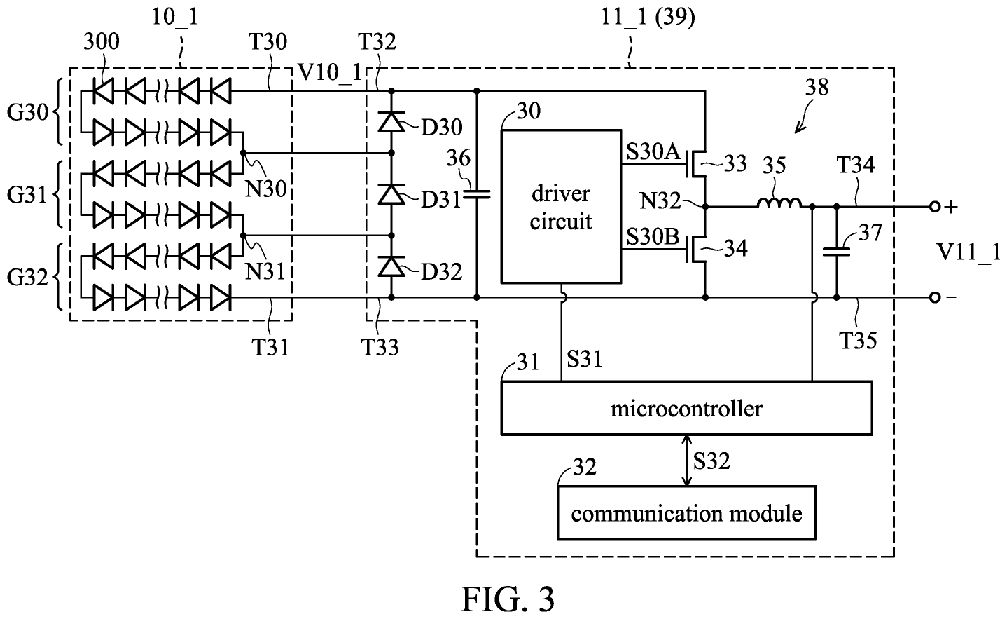

FIG. 3 shows an exemplary embodiment of the solar photovoltaic panel 10_1 and the DC optimizer 11_1. Referring to FIG. 3, the solar photovoltaic panel 10_1 comprises a plurality of solar cells 300 that are connected in series between the positive output terminal T30 and the negative output terminal T31 of the solar photovoltaic panel 10_1. In the embodiment, the plurality of solar cells 300 is divided into three solar cell groups G30-G32, and the solar cell groups G30-G32 are connected in series. Specifically, the solar cells 300 of the solar cell group G30 are connected in series between the positive output terminal T30 and a node N30, the solar cells 300 of the solar cell group G31 are connected in series between the node N30 and a node N31, and the solar cells 300 of the solar cell group G32 are connected in series between the node N31 and the negative output terminal T31.

The DC optimizer 11_1 comprises a driver circuit 30, a microcontroller 31, a communication module 32, switching transistors 33 and 34, an inductor 35, an input capacitor 36, an output capacitor 37, and protection diodes D30-D32. The driver circuit 30, the switching transistors 33 and 34, the inductor 35, the input capacitor 36, and the output capacitor 37 form a buck converter 38. In the embodiment, the driver circuit 30, the microcontroller 31, the communication module 32, the switching transistors 33 and 34, the inductor 35, the input capacitor 36, and the output capacitor 37 form a sub-DC optimizer 39. In other words, the DC optimizer 11_1 comprises a single sub-DC optimizer 39. The DC optimizer 11_1 has a positive input terminal T32 and a negative input terminal T33 that are coupled to the positive output terminal T30 and the negative output terminal T31 of the solar photovoltaic panel 10_1 respectively. The cathode of the protection diode D30 is coupled to the positive input terminal T32 of the DC optimizer 11_1 (that is, the positive output terminal T30 of the solar photovoltaic panel 10_1), and the anode thereof is coupled to the node N30. The cathode of protection diode D31 is coupled to the node N30, and the anode thereof is coupled to the node N31. The cathode of the protection diode D32 is coupled to the node N31, and the anode thereof is coupled to the negative input terminal T33 of the DC optimizer 11_1 (that is, the negative output terminal T31 of the solar photovoltaic panel 10_1).

The input capacitor 36 is coupled between the positive input terminal T32 and the negative input terminal T33 of the DC optimizer 11_1. In the embodiment, the switching transistors 33 and 34 are implemented as N-type metal-oxide-semiconductor (NMOS) transistors. In the following description, the switching transistors 33 and 34 are referred to as NMOS transistors. Each of the NMOS transistors 33 and 34 has a gate, a drain, and a source. The drain of the NMOS transistor 33 is coupled to the positive input terminal T32, the gate thereof is coupled to the driver circuit 30 to receive a driving signal S30A, and the source thereof is coupled to the node N32. The drain of the NMOS transistor 34 is coupled to the node N32, the gate thereof is coupled to the driver circuit 30 to receive a driving signal S30B, and the source thereof is coupled to the negative input terminal T33. The on/off states of the NMOS transistors 33 and 34 are controlled by the driving signals S30A and S30B respectively. It should be noted that the NMOS transistors 33 and 34 are not turned on at the same time.

The DC optimizer 11_1 has a positive output terminal (+) T34 and a negative output terminal (−) T35. The negative input terminal T33 of the DC optimizer 11_1 is directly connected to the negative output terminal T35 thereof. The inductor 35 is coupled between the node N32 and the positive output terminal (+) T34 of the DC optimizer 11_1. The output capacitor 37 is coupled between the positive output terminal (+) T34 and the negative output terminal (−) T35.

The DC optimizer 11_1 receives the solar voltage V10_1 generated by the solar photovoltaic panel 10_1 through the positive input terminal T32 and the negative input terminal T33. The driver circuit 30 receives the pulse width modulation signal S31 generated by the microcontroller 31 to generate driving signals S30A and S30B. The driver circuit 30 controls the on/off states of the NMOS transistors 33 and 34 through the driving signals S30A and S30B, so that the inductor 35 is charged or discharged. Thus, the conversion voltage V11_1 is generated between the positive output terminal (+) T34 and the negative output terminal (−) T35s. The output capacitor 37 stores the conversion voltage V11_1. According to the above description, the voltage decreasing operation of the DC optimizer 11_1 is completed according to the duty cycle of the pulse width modulation signal S31 and further through the driver circuit 30, NMOS transistors 33 and 34, the inductor 35, the input capacitor 36, and the output capacitor 37.

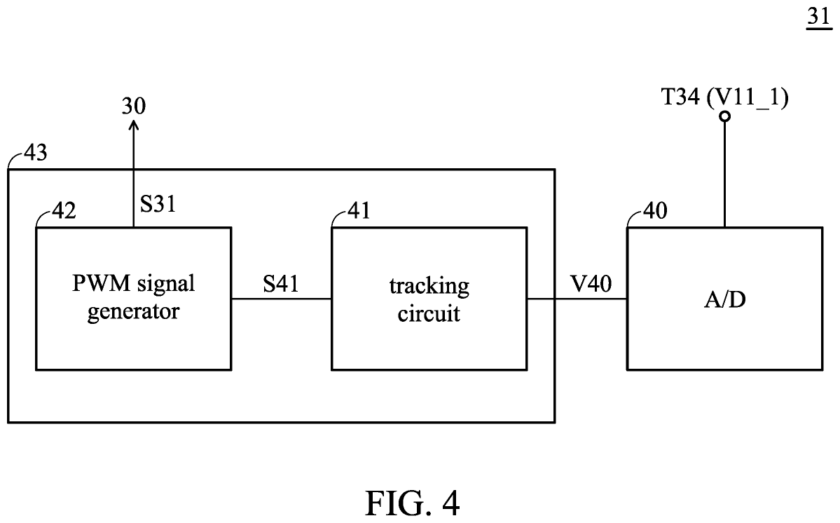

The microcontroller 31 is coupled to the positive output terminal (+) T34 to receive the conversion voltage V11_1 and adjusts the duty cycle of the pulse width modulation signal S31 according to the conversion voltage V11_1, thereby changing the conversion voltage V11_1. Referring to FIG. 4, the microcontroller 31 comprises an analog-to-digital (A/D) converter 40 and a pulse width modulation (PWM) signal adjustment circuit 43. The PWM signal adjustment circuit 43 comprises a tracking circuit 41 and a pulse width modulation (PWM) signal generator 42. The analog-to-digital (A/D) converter 40 is coupled to the positive output terminal T34 of the DC optimizer 11_1 to receive the conversion voltage V11_1 and performs an analog-to-digital conversion operation on the conversion voltage V11_1 to generate a voltage value V40. The tracking circuit 41 receives the voltage value V40 and performs the maximum-voltage tracking operation on the voltage value V40 to generate an adjustment signal S41. The PWM signal generator 42 is used to generate the pulse width modulation signal S31. The PWM signal generator 42 receives the adjustment signal S41 and adjusts the duty cycle of the pulse width modulation signal S31 according to the adjustment signal S41.

Referring to FIG. 3, the microcontroller 31 is configured to receive a control signal S32 transmitted by a host (not shown in the figures) through the communication module 32. Through the control signal S32, the microcontroller 31 can be controlled to adjust the duty cycle of the pulse width modulation signal S31. Through the communication performed by the communication module 32, a host can shut down the output voltage (that is, the solar voltage V10_1) of the solar photovoltaic panel 10_1 in an emergency based on the safety specification. For example, the microcontroller 31 adjusts the duty cycle of the pulse width modulation signal S31 to 0% or to a value close to 0% according to the control signal S32, thereby turning off the output voltage of the solar photovoltaic panel 10_1.

In addition, the microcontroller 31 can transmit status information (for example, solar voltage V10_1) of the solar photovoltaic panel 10_1 to a host through the communication module 32. In one embodiment, after the host receives the status information of the solar photovoltaic panel 10_1, the host may further determine whether the solar photovoltaic panel 10_1 needs to be cleaned or repaired.

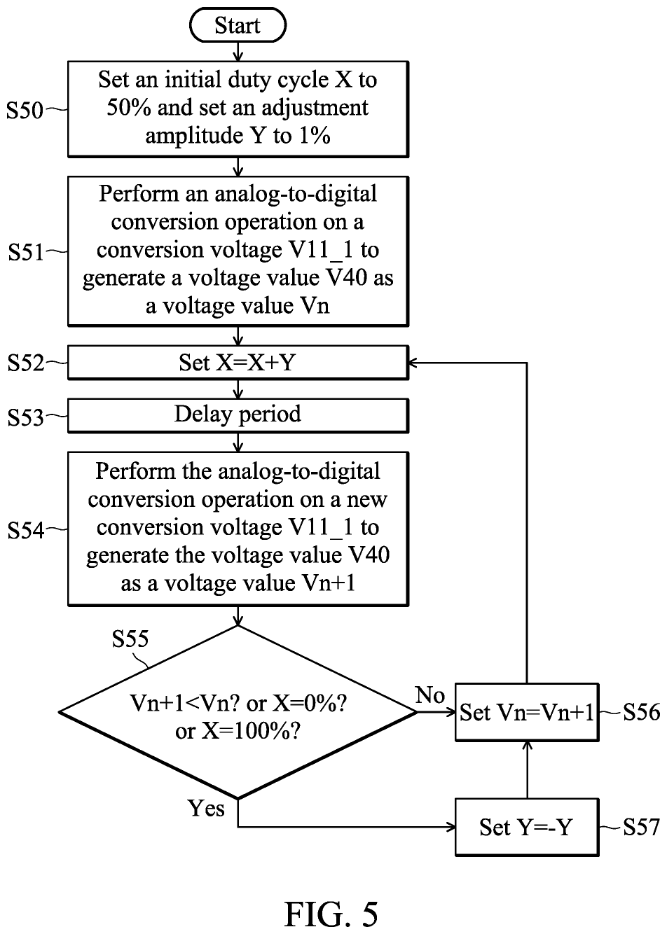

FIG. 5 is a flow chart of an exemplary embodiment of the maximum-voltage tracking. The maximum-voltage tracking operation will be explained below through FIGS. 3-5. In the following description, the maximum duty cycle of the pulse width modulation signal S31 is 100% as an example to illustrate the maximum-voltage tracking operation.

Referring to FIG. 5, when the microcontroller 31 starts operating, in Step S50, the tracking circuit 41 sets an initial duty cycle X of the pulse width modulation signal S31 to 50% and sets an adjustment amplitude Y used for adjusting the duty cycle to 1%. In other words, the adjustment amplitude Y is initially set to a positive value, that is, the adjustment direction of the duty cycle is initially set to an increasing direction. The present invention does not intend to limit the initial duty cycle X and the initial adjustment amplitude Y. In other embodiments, the initial duty cycle X and the initial adjustment amplitude Y can be determined according to system requirements. After Step S50, the buck converter 38 performs the voltage decreasing operation according to the pulse width modulation signal S31 with the duty cycle of 50% to generate the conversion voltage V11_1, and the analog-to-digital converter 40 performs the analog-to-digital conversion operation on the conversion voltage V11_1 to generate the voltage value V40 as a voltage value Vn (Step S51). Then, the PWM signal generator 42 adds 1% (Y) to the duty cycle of 50% (X) as a new duty cycle X, that is, X=X+Y=50%+1%=51% (Step S52). During a delay period (Step S53), the buck converter 38 performs the voltage decreasing operation according to the pulse width modulation signal S31 with the duty cycle of 51% to generate a new conversion voltage V11_1. After the delay period, the analog-to-digital converter 40 performs the analog-to-digital conversion operation on the new conversion voltage V11_1 to generate the voltage value V40 as a voltage value Vn+1 (Step S54).

After the voltage value Vn+1 is obtained, the tracking circuit 41 determines whether the voltage value Vn+1 is less than the voltage value Vn (Vn+1<Vn?) (Step S56). In Step S56, the tracking circuit 41 further determines whether the duty cycle X is equal to 0% (X=0%?) and whether the duty cycle X is equal to 100% (X=100%?) and generates the adjustment signal S41 according to the determination result. When the tracking circuit 41 determines that the voltage value Vn+1 is not less than the voltage value Vn, the duty cycle X is not equal to 0%, and the duty cycle X is not equal to 100% (Step S55—No), the method proceeds to Step S56. In Step S56, the tracking circuit 41 ser the current voltage value Vn+1 as a new voltage value Vn (Vn=Vn+1). At this time, the adjustment amplitude Y remains at 1% (a positive value). This case indicates that the PWM signal generator 42 continues to increase the duty cycle. The tracking circuit 41 determines whether the voltage value V40 reaches the maximum voltage (that is, the tracking circuit 41 tracks the maximum voltage) when the duty cycle is increased.

When the tracking circuit 41 determines that the voltage value Vn+1 is less than the voltage value Vn, the duty cycle X is equal to 0%, or the duty cycle X is equal to 100% (Step S55—Yes), the method proceeds to Step S57. In Step S57, the tracking circuit 41 reverses the adjustment direction of the duty cycle (that is, the adjustment direction of the duty cycle changes to a decreasing direction). In other words, the tracking circuit 41 changes the polarity of the adjustment amplitude Y (setting Y=−Y=−1%), that is, the adjustment amplitude Y changes from a positive value to a negative value. This case indicates that the PWM signal generator 42 decreases the duty cycle. In the case where the duty cycle is decreased, the tracking circuit 41 determines whether the voltage value V40 reaches the maximum voltage (that is, the tracking circuit 41 tracks the maximum voltage). After Step S57, the tracking circuit 41 sets the current voltage value Vn+1 as a new voltage value Vn (Vn=Vn+1) (Step S56).

In the embodiment of the present invention, the adjustment signal S41 indicates that the adjustment amplitude Y is a positive value or a negative value, that is, the adjustment signal S41 indicates the adjustment direction of the duty cycle. After Step S56, the method returns to Step S52. The PWM signal generator 42 adds 1% to the duty cycle of 51% according to the adjustment signal S41 as a new duty cycle X (that is, X=X+Y=51%+1%=52%), or the PWM signal generator 42 subtracts 1% from the duty cycle of 51% according to the adjustment signal S41 as a new duty cycle X (that is, X=X+Y=51%+(−1%)=50%). The method continues to Step S53 and Step S54 and then to the determination Step S55. Then, the process of the maximum voltage tracking in the embodiment is to perform Step S52 to Step S57.

It should be noted here that in Step S55, the case where the duty cycle X is equal to 0% or the duty cycle X is equal to 100% (Step S55—Yes) indicates that the duty cycle has reached the minimum value of 0% when the adjustment direction is the decreasing direction or that the duty cycle X has reached the maximum value of 100% when the adjustment direction is the increasing direction. At this time, the tracking circuit 41 reverses the adjustment direction of the duty cycle to continue to track the maximum voltage.

According to the flow chart of the maximum voltage tracking shown in FIG. 5, the microcontroller 31 tracks the maximum voltage value of the conversion voltage V11_1 so that the solar photovoltaic panel 10_1 can operate at the maximum output power point.

According to the above embodiment, each of the DC optimizers 11_1-11_14 only comprises a buck converter without any boost converter, which reduces the circuit complexity of the DC optimizer and further reduces the area and the cost of the DC optimizer.

Furthermore, according to the above embodiment, each of the DC optimizers 11_1-11_14 only tracks the maximum voltage, but does not sense a current by arranging a sensing resistor. Then, the corresponding solar photovoltaic panel operating at the maximum output power point can be also achieved. Accordingly, each of the DC optimizers 11_1-11_14 does not perform complex operations and can operate independently without communicating with other DC optimizers, thereby adjusting their respective conversion voltages in real time.

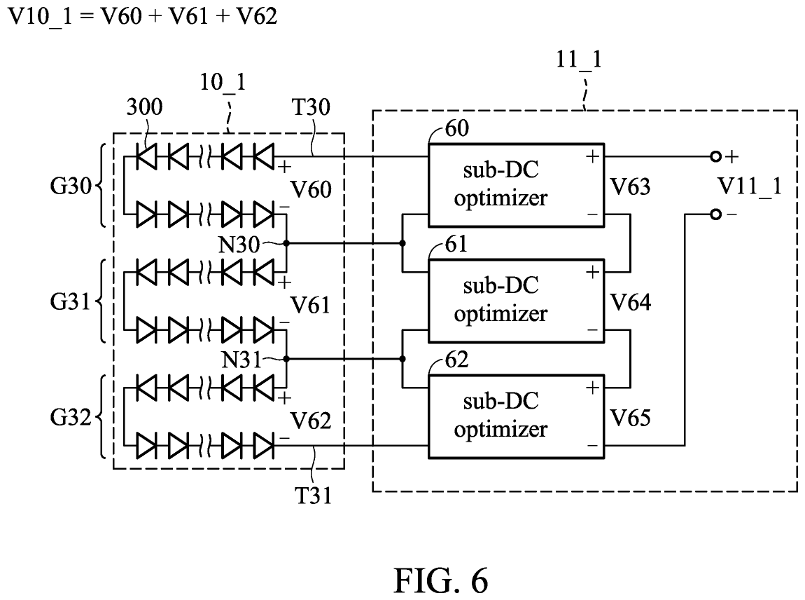

In the above embodiment, all the solar cell groups G30-G32 of the solar photovoltaic panel 10_1 correspond to a single sub-DC optimizer 39. In other embodiments, as shown in FIG. 6, the DC optimizer 11_1 comprises sub-DC optimizers 60-62, which respectively correspond to the solar cell groups G30-G32. It should be noted that in the embodiment of FIG. 6, the DC optimizer 11_1 does not comprise the protection diodes D30-D32. The solar cell group G30 converts light energy into electrical energy to generate a solar voltage V60, the solar cell group G31 converts light energy into electrical energy to generate a solar voltage V61, and the solar cell group G32 converts light energy into electrical energy to generate a solar voltage V62. The sum of the solar voltages V60-V62 serves as the solar voltage V10_1 generated by the solar photovoltaic panel 10_1.

The sub-DC optimizers 60-62 are connected in a series structure. As shown in FIG., each sub-DC optimizer has a positive output terminal (+) and a negative output terminal (−). The negative output terminal of the sub-DC optimizer 60 is coupled to the positive output terminal of the sub-DC optimizer 61, and the negative output terminal of the sub-DC optimizer 61 is coupled to the positive output terminal of the sub-DC optimizer 62. The positive output terminal of the sub-DC optimizer 60 and the negative output terminal of the sub-DC optimizer 62 are coupled to the positive output terminal and the negative output terminal of the DC optimizer 11_1 respectively. Each sub-DC optimizer performs a voltage decreasing operation on the received solar voltage based on a pulse width modulation signal to generate a corresponding conversion voltage. For example, the sub-DC optimizer 60 performs a voltage decreasing operation on the received solar voltage V60 to generate a corresponding conversion voltage V63, the sub-DC optimizer 61 performs a voltage decreasing operation on the received solar voltage V61 to generate a corresponding conversion voltage. V64, and the sub-DC optimizer 62 performs a voltage decreasing operation on the received solar voltage V62 to generate a corresponding conversion voltage V65. For each sub-DC optimizer, during the voltage decreasing operation, the sub-DC optimizer also changes the generated conversion voltage by adjusting the duty cycle of the corresponding pulse width modulation signal so that the corresponding solar photovoltaic panel can operates at its maximum output power point. In the embodiment, the sum of the conversion voltages V63-V65 serves as the conversion voltage V11_1 generated by the DC optimizer 11_1.

In the embodiment of FIG. 6, each of the sub-DC optimizers 60 to 62 comprises the microcontroller 31, the communication module 32, and the buck converter 38 of the sub-DC optimizer 39 shown in FIG. 3. The operation of each of the sub-DC optimizers 60-62 is similar to the operation of the sub-DC optimizer 39 shown in FIG. 3, and the related description is omitted here.

In the embodiment of FIG. 6, the conversion voltage V11_1 is equal to the sum of the conversion voltages V63-V65. Since the sub-DC optimizers 60-62 change the conversion voltages V63-V65 respectively, the DC optimizer 11_1 can change the conversion voltage V11_1 more finely, that is, the DC optimizer 11_1 can more accurately track the maximum voltage value of the conversion voltage V11_1.

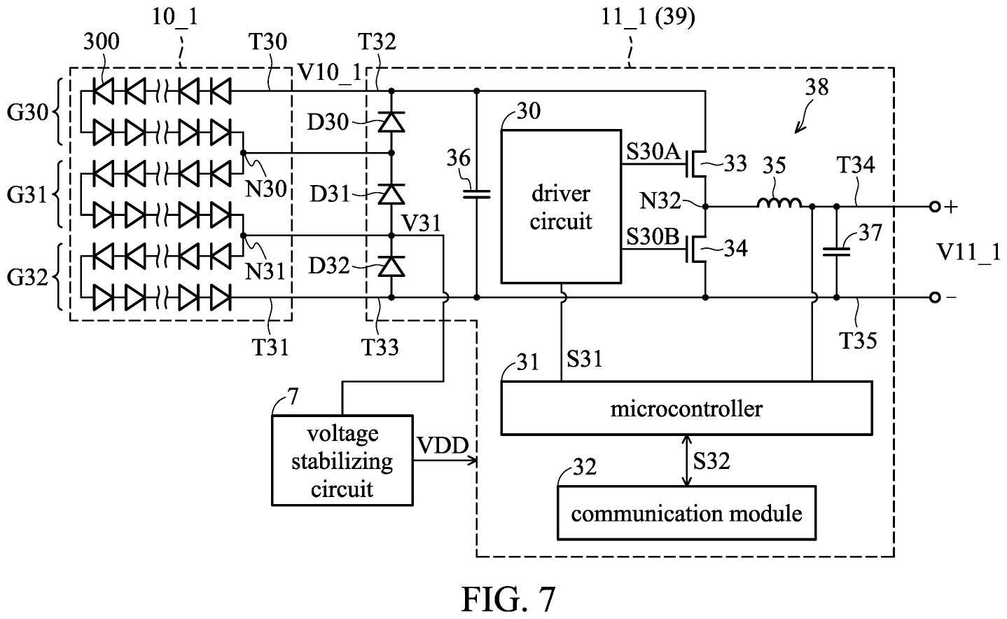

In one embodiment, for a solar photovoltaic panel and a corresponding DC optimizer, a voltage stabilizing circuit can be provided. The voltage stabilizing circuits generates an operating voltage according to a voltage provided by the corresponding solar photovoltaic panel to provide power to the corresponding DC optimizer. For example, referring to FIG. 7, for the solar photovoltaic panels 10_1 and the corresponding DC optimizer 11_1, a voltage stabilizing circuit 7 is arranged. In this embodiment, the voltage stabilizing circuit 7 is coupled to a node between any two solar cells of the plurality of series-connected solar cells, such as node N31, to receive the voltage V31 ats the node N31. The voltage stabilizing circuit 7 generates the operation voltage VDD based on the voltage V31. The operating voltage VDD is provided to the DC optimizer 11_1 to power at least one of the driver circuit 30, the microcontroller 31, and the communication module 32.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A solar power system, comprising:
a first solar photovoltaic panel converting light energy into electrical energy to generate a first solar voltage; and
a first direct-current (DC) optimizer receiving the first solar voltage and performing a first voltage decreasing operation on the first solar voltage according to a first pulse width modulation signal to generate a first conversion voltage,
wherein the first DC optimizer adjusts a first duty cycle of the first pulse width modulation signal according to the first conversion voltage.

2. The solar power system as claimed in claim 1, wherein the first solar photovoltaic panel comprises:
a plurality of solar cells connected in series,
wherein the plurality of solar cells convert light energy into electrical energy to generate the first solar voltage.

3. The solar power system as claimed in claim 1, wherein the first solar photovoltaic panel and the first DC optimizer are arranged on a single solar power module.

4. The solar power system as claimed in claim 1 further comprising:
a power inverter coupled to the first DC optimizer;
wherein the power inverter receives the first conversion voltage and generates an alternating-current (AC) output voltage according to the first conversion voltage.

5. The solar power system as claimed in claim 1, further comprising:
a second solar photovoltaic panel converting light energy into electrical energy to generate a second solar voltage; and
a second DC optimizer receiving the second solar voltage and performing a second voltage decreasing conversion operation on the second solar voltage according to a second pulse width modulation signal to generate a second conversion voltage,
wherein the second DC optimizers adjusts a second duty cycle of the second pulse width modulation signal according to the second conversion voltage.

6. The solar power system as claimed in claim 5, further comprising:
a power inverter coupled to the first DC optimizer and the second DC optimizer;
wherein the first DC optimizer and the second DC optimizer output the first conversion voltage and the second conversion voltage in series to generate a series DC input voltage, and
wherein the power inverter receives the series DC input voltage and converts the series DC input voltage into an AC output voltage.

7. The solar power system as claimed in claim 1, wherein:
the first solar photovoltaic panel comprises:
a first solar cell group comprising a plurality of first solar cells connected in series, wherein the first solar cell group converts light energy into electrical energy to generate the first solar voltage; and
a second solar cell group, electrically connected to the first solar cell group, comprising a plurality of second solar cells connected in series, wherein the second solar cell group converts light energy into electrical energy to generate a second solar voltage; and
the first DC optimizer comprises:
a first sub-DC optimizer receiving the first solar voltage and performing the first voltage decreasing operation on the first solar voltage according to the first pulse width modulation signal to generate the first conversion voltage; and
a second sub-DC optimizer receiving the second solar voltage and performing a second voltage decreasing operation on the second solar voltage according to a second pulse width modulation signal to generate a second conversion voltage,
wherein the first sub-DC optimizer adjusts the first duty cycle of the first pulse width modulation signal according to the first conversion voltage, and the second DC optimizer adjusts a first duty cycle of the second pulse width modulation signal according to the second conversion voltage.

8. The solar power system as claimed in claim 7, wherein the first solar cell group, the second solar cell group, the first sub-DC optimizer, and the second sub-DC optimizer are arranged on the same solar power module.

9. The solar power system as claimed in claim 7, further comprising:
a power inverter coupled to the first sub-DC optimizer and the second sub-DC optimizer,
wherein the first sub-DC optimizer and the second sub-DC optimizer output the first conversion voltage and the second conversion voltage in series to generate a series DC input voltage, and
wherein the power inverter receives the series DC input voltage and converts the series DC input voltage into an AC output voltage.

10. The solar power system as claimed in claim 1, wherein the first DC optimizer comprises:
a buck converter receiving the first solar voltage and performing the voltage decreasing operation on the first solar voltage according to the first pulse width modulation signal to generate the first conversion voltage;
an analog-to-digital converter receiving the first conversion voltage and performing an analog-to-digital conversion operation on the first conversion voltage to generate a voltage signal; and
a microcontroller receiving the voltage signal and adjusting the first duty cycle of the first pulse width modulation signal according to the voltage signal thereby tracking a maximum output voltage of the first DC optimizer.

11. The solar power system as claimed in claim 10, wherein the first DC optimizer further comprises:
a communication module coupled to the microcontroller;
wherein the microcontroller is configured to perform to:
receive a control signal through the communication module and adjust the first duty cycle of the first pulse width modulation signal according to the control signal; or
transmit status information of the first solar photovoltaic panel to the outside through the communication module.
